(19) United States
(12) Patent Application Publication
(10) Pub. No.: US 2017/0161560 A1
(43) Pub. Date: Jun. 8, 2017

(54) SYSTEM AND METHOD FOR HARVEST YIELD PREDICTION

(71) Applicant: Prospera Technologies, Ltd., Tel-Aviv (IL)

(72) Inventors: Raviv ITZHAKY, Maale Adumim (IL); Daniel KOPPEL, Raanana (IL); Simeon SHPIZ, Bat Yam (IL)

(73) Assignee: Prospera Technologies, Ltd., Tel-Aviv (IL)

(21) Appl. No.: 15/438,370

(22) Filed: Feb. 21, 2017

Related U.S. Application Data
(63) Continuation-in-part of application No. 14/950,594, filed on Nov. 24, 2015.
(60) Provisional application No. 62/297,872, filed on Feb. 21, 2016.
(60) Provisional application No. 62/083,492, filed on Nov. 24, 2014.

(51) Int. Cl. G06K 9/00; A01G 1/00; G06K 9/46; G06N 3/08; G06N 3/04

(52) U.S. Cl. CPC G06K 9/00657; G06N 3/08; G06N 3/04; G06K 9/4604; G06K 9/4652; A01G 1/001; G06K 2209/17; G06K 9/6232

(57) ABSTRACT

A system and method for predicting harvest yield. The method includes receiving monitoring data related to at least one crop, wherein the monitoring data includes at least one multimedia content element showing the at least one crop; analyzing, via machine vision, the at least one multimedia content element; extracting, based on the analysis, a plurality of features related to development of the at least one crop; and generating a harvest yield prediction for the at least one crop based on the extracted features and a prediction model, wherein the prediction model is based on a training set including at least one training input and at least one training output, wherein each training output corresponds to a training input.

### CROSS-REFERENCE TO RELATED APPLICATIONS

This application claims the benefit of U.S. Provisional Application No. 62/297,872 filed on Feb. 21, 2016. This application is also a continuation-in-part of U.S. patent application Ser. No. 14/950,594 filed on Nov. 24, 2015, now pending, which claims the benefit of U.S. Provisional Application No. 62/083,492 filed on Nov. 24, 2014, the contents of which are hereby incorporated by reference.

### TECHNICAL FIELD

The present disclosure relates generally to agricultural monitoring, and more specifically to harvest yield prediction using agricultural monitoring systems.

### BACKGROUND

Despite the rapid growth of the use of technology in many industries, agriculture continues to utilize manual labor to perform the tedious and often costly processes for growing vegetables, fruits, and other crops. One primary driver of the continued use of manual labor in agriculture is the need for guidance and consultation by experienced agronomists with respect to developing plants. Such guidance and consultation is crucial to the success of larger farms.

Agronomy is the science of producing and using plants for food, fuel, fiber, and land reclamation. Agronomy involves use of principles from a variety of arts including, for example, biology, chemistry, economics, ecology, earth science, and genetics. Modern agronomists are involved in issues such as improving quantity and quality of food production, managing the environmental impacts of agriculture, extracting energy from plants, and so on. Agronomists often specialize in areas such as crop rotation, irrigation and drainage, plant breeding, plant physiology, soil classification, soil fertility, weed control, and insect and pest control.

The plethora of duties assumed by agronomists require critical thinking to solve problems. For example, when planning to improve crop yields, an agronomist must study a farm's crop production in order to discern the best ways to plant, harvest, and cultivate the plants, regardless of climate. Additionally, agronomists may predict crop yield, which is the measure of agricultural output. To these ends, the agronomist must continually monitor progress to ensure optimal results. Based on the presence or lack of developmental problems as well as observation of plant growth, agronomists may be further able to estimate the yield at harvest.

Crop yield forecasts can be utilized by farmers to plan post-harvesting sales of crops. Specifically, if a farmer knows the crop yield in advance, he or she can contract to sell all of his or her crops without risking breaking agreements due to, e.g., not producing sufficient amounts of crops. Additionally, the farmer can secure more competitive prices for crops than, for example, if the crop production is greater than what was contracted such that the farmer is forced to sell crops at discounted prices to prevent crops from being wasted. Accordingly, predicting crop yield accurately is incredibly useful for agricultural-based businesses.

Reliance on manual observation of plants is time-consuming, expensive, and subject to human error. Moreover, forecasting plant yields based on manual observation typically results in only a rough estimate even when the plants are observed frequently. Additionally, agronomists' predictions for yield may be further inaccurate due to, for example, failure to perceive signs of improper development, failure to properly consider long-term trends in plant development, failure to account for key factors in plant development, and the like. In particular, statistical models used by agronomists typically cannot account for at least some factors such as plant characteristics, weather, management practices, historical data for multiple time periods or locations, or other relevant factors, thereby resulting in predictions that may be imprecise at best, and entirely inaccurate at worst.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for predicting crop yield. The method comprises: receiving monitoring data related to at least one crop, wherein the monitoring data includes at least one multimedia content element showing the at least one crop; analyzing, via machine vision, the at least one multimedia content element; extracting, based on the analysis, a plurality of features related to development of the at least one crop; and generating a harvest yield prediction for the at least one crop based on the extracted features and a prediction model, wherein the prediction model is based on a training set including at least one training input and at least one training output, wherein each training output corresponds to a training input.

The disclosed embodiments also include a non-transitory computer readable medium having stored thereon instructions for causing a processing circuitry to execute a process, the process comprising: receiving monitoring data related to at least one crop, wherein the monitoring data includes at least one multimedia content element showing the at least one crop; analyzing, via machine vision, the at least one multimedia content element; extracting, based on the analysis, a plurality of features related to development of the at least one crop; and generating a harvest yield prediction for the at least one crop based on the extracted features and a prediction model, wherein the prediction model is based on a training set including at least one training input and at least one training output, wherein each training output corresponds to a training input.

The disclosed embodiments also include a system for predicting crop yield. The system comprises: a processing circuitry; and a memory, the memory containing instructions that, when executed by the processing circuitry, configure the system to: receive monitoring data related to at least one crop, wherein the monitoring data includes at least one multimedia content element showing the at least one crop; analyze, via machine vision, the at least one multimedia content element; extract, based on the analysis, a plurality of features related to development of the at least one crop; and generate a harvest yield prediction for the at least one crop based on the extracted features and a prediction model, wherein the prediction model is based on a training set including at least one training input and at least one training output, wherein each training output corresponds to a training input.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a system for harvest yield prediction utilized to describe the various disclosed embodiments.

FIG. 2 is a flowchart illustrating a method for harvest yield prediction according to an embodiment.

FIGS. 3A and 3B are flow diagrams illustrating a training phase and a test phase, respectively, of a method for predicting harvest yields based on automatic plant monitoring according to an embodiment.

FIG. 4 is a flowchart illustrating a method for identifying deviations from common growth patterns.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments include a method and system for predicting harvest yield. A set of training inputs is obtained and analyzed. A predictive function is generated based on the training input set. A set of application inputs related to at least one crop is obtained and analyzed. Based on the application inputs, application features are determined. The application features are related to a target area including at least one crop. Based on the application features and the predictive function, a prediction of harvest yield for the at least one crop target area is determined.

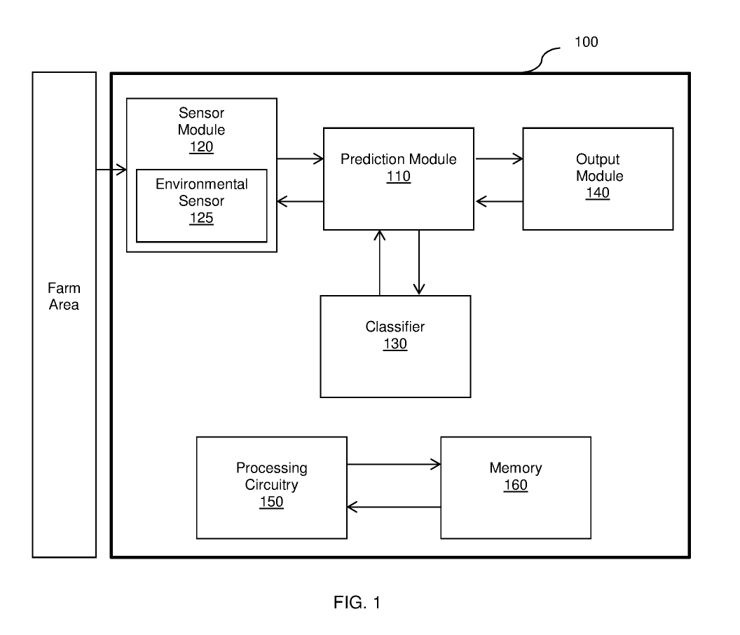

Fig. 1 shows an example schematic diagram of a system 100 for harvest yield prediction utilized to describe the various disclosed embodiments. The system 100 includes a prediction module 110, a sensor module 120, a classifier 130, an output module 140, a processing circuitry 150, and a memory 160.

In an embodiment, the prediction module 110 is configured to use a predictive function for predicting harvest yield for plants on a target area based on application features. In a further embodiment, the prediction module 110 is configured to determine the application features based on monitoring data of, e.g., a monitored plant in the target area. The target area may be a farm area such as, but not limited to, an outdoor area in which plants are grown (e.g., an open field), an indoor area in which crops are grown (e.g., protected crops or greenhouses), an incubator, or any other location in which plants are grown. Such crops may include, but are not limited to, fruits, trees, leaves, roots, crops, flowers, inflorescence, and so on.

The sensor module 120 may be configured to acquire the monitoring data used to derive the application features and to transmit the monitoring data to the prediction module 110. The monitoring data includes, but is not limited to, images, videos, environmental sensor inputs, or both, showing the target area including at least one crop. In a typical embodiment, the images include high resolution images. The images may include stationary images (i.e. images from a static viewpoint), dynamic images, videos, or a combination thereof.

Alternatively or collectively, the monitoring data may include characteristics of the crops or the target area related to plant growth such as, but not limited to, soil type, soil measurements (e.g., salinity, pH, etc.), seed type, sowing time, amount and scheduling of irrigation, type and scheduling of fertilizer, type and scheduling of pesticides and/or insecticides, and so on. In an embodiment, the prediction module 110 may receive the characteristics from an input device (not shown), which may be, but is not limited to, a user input device.

In an embodiment, the sensor module 120 may include an image capturing device (not shown) such as, but not limited to, a still camera, a red-green-blue camera, a multi spectral camera, a hyper spectral camera, a video camera, and the like. The image capturing device may be stationary or moveable (e.g., by being assembled on a drone or vehicle), and may be configured to capture images, videos, or both (hereinafter referred to as images, merely for simplicity purposes), of a target area including at least one crop. The image capturing device may be a high-resolution imaging device configured to capture high resolution images.

The images may include, but are not limited to, a series of images captured sequentially from the same viewpoint (e.g., at a predetermined angle and position with respect to the target area, or within predetermined ranges of angles and positions) with substantially similar optical characteristics. The images in the applied image sequence may be captured periodically. Further, the time intervals between captured images may be sufficient to demonstrate stages of crop development and may be, but are not limited to, minutes, hours, days, weeks, and so on. The resolution of the applied images is sufficient to identify one or more portions of the crops.

The sensor module 120 may include a processing circuitry for processing the data acquired by the sensor module 120 and a communication unit for enabling communication with the prediction module 110 over a telecommunication network. The prediction module 110 and the sensor module 120 may be configured to communicate using a wireless communication data link such as a 3G or a Wifi connection.

The sensor module 120 may optionally include an environmental sensor 125. The environmental sensor 125 may further include a plurality of environmental sensor units (not shown) such as, but not limited to, a temperature sensor unit, a humidity sensor unit, a soil moisture sensor unit, a sunlight sensor unit, an irradiance sensor unit, a size measurement apparatus, and so on. In some embodiments, the plurality of environmental sensor units may be housed in a single sensor module housing (not shown). In another embodiment, the environmental sensor units may be spatially distributed but communicatively connected to the communication unit of the sensor module 120.

In some embodiments, the sensor module 120 may be autonomously powered, for example using a solar panel. In some embodiments, the time intervals between the acquired images (and optionally between the acquired environmental parameters) may depend on the powering capabilities of the sensor module 120. As an example, a sensor module having higher power capabilities may capture images more frequently than a sensor module having lower power capabilities. Similarly, in an embodiment, the resolution of at least one image may depend on the powering capabilities of the sensor module 120. In some embodiments, the resolution of the images may be dynamically adapted in accordance with the powering capabilities of the sensor module 120. Thus, the resolution of the images may vary depending upon the current power capabilities of the sensor module 120 at any given time. Such power capabilities may change when, for example, the sensor module 120 is connected to a different power source, the sensor module 120 is replaced, and so on. In some embodiments, a resolution of the images acquired may be altered to lower the amount of data communicated to the prediction module 110, thereby decreasing power consumption of the sensor module 120.

In an embodiment, the sensor module 120 may be further configured to switch on/off in accordance with a predetermined time schedule based on the predetermined image frequency and, optionally, based on the predetermined frequencies for the monitoring data so that the sensor module may only be switched on when it is acquiring data. This switching between off and on may enable reduced power consumption by the sensor module 120.

In an embodiment, the sensor module 120 may be configured to preprocess the captured applied inputs. The preprocessing may include, but is not limited to, applying a transformation to each image, to one or more environmental sensor inputs, to one or more characteristics, or a combination thereof. For example, the sensor module 120 may downsize the images acquired via an imaging device. In a further embodiment, the preprocessing may include utilizing an optical flow algorithm.

In an embodiment, the prediction module 110 may be communicatively connected to the classifier 130, thereby allowing the prediction module 110 to apply a prediction model generated by the classifier 130 to the test inputs captured via the sensor module 120. The classifier 130 may be configured to determine a predictive function based on a training set including training inputs linked to training outputs. The estimation of the prediction model may be performed preliminarily. In an embodiment, the classifier 130 may be further configured to perform testing, validation, or both, on the prediction model to refine the model, validate the model, or both.

To enable determination of which predictive function the prediction module 110 should use, the classifier 130 may be configured to determine the predictive function based on training sets using machine learning techniques. For example, the classifier 130 may use convolutional neural network layer(s) optionally combined with feed forward neural network layer(s) to estimate the predictive function “f.” Thus, in an example embodiment, building the classifier may include, but is not limited to: building matrixes from the training image sequences based on an image pixel abscissa, an image pixel ordinate, an image pixel color, an image index, or a combination thereof; and feeding the matrixes to one or more (e.g., 5) layers of convolutional neural network with one or more (e.g., 3) other fully connected layers.

The prediction module 110 may further be configured to output a harvest yield prediction for the target area to the output module 140 by applying a prediction model generated by the classifier 130 to application features related to development of the at least one crop. The application features may include, but are not limited to, plant stage (e.g., a stage in development during a life cycle of the crop), a crop size, disease spread, and the like. The application features may further include characteristics of the at least one crop, environmental parameters of the target area, or both. In a further embodiment, the prediction module 110 is configured to extract the application features based on the monitoring data received from the sensor module 120.

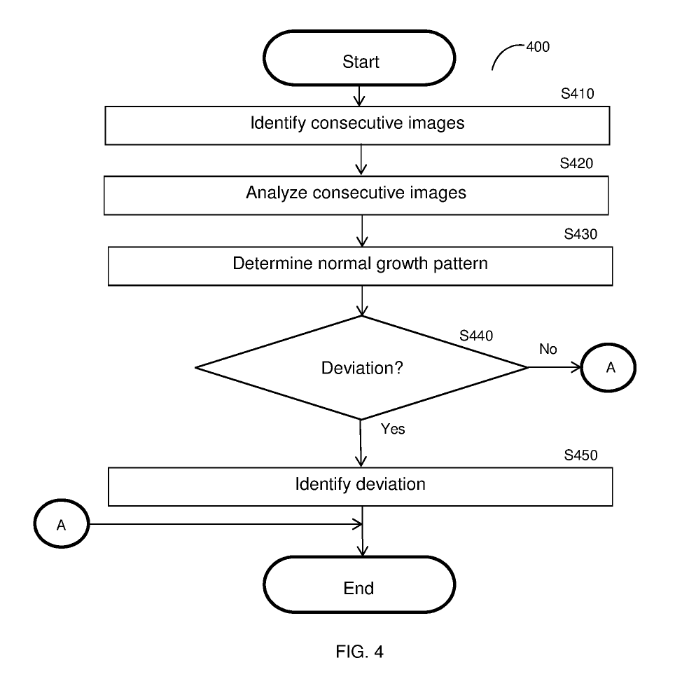

In yet a further embodiment, extracting the application features may include selecting data from among the received monitoring data, analyzing at least a portion of the received monitoring data, and the like. The analysis of the monitoring data may further include machine vision analysis on images showing one or more crops for which harvest yield is to be predicted. The machine vision analysis may include identifying crop attributes such as, but not limited to, at least one color of a crop, a color ration between portions of a crop, texture, color division, size, shape, growth data, or a combination thereof. The growth data may further include, but are not limited to, growth rate, deviations from normal growing patterns, past activity, spread of the crop, and the like. Identifying deviations from normal growing patterns is described further herein below with respect to FIG. 4. The identified crop attributes may be utilized as features to be input to the prediction model.

The harvest yield prediction is an estimated agricultural output that may be expressed as, but not limited to, the yield of a crop per unit area of cultivated land, seed generation for a plant or group of plants, and the like. The harvest yield prediction may further include a timeline indicating predicted harvest yield values at various times such that each harvest yield prediction demonstrates an estimated yield at a given time. The harvest yield prediction is based on application of the prediction model to the monitoring data, the characteristics, the identified attributes, or a combination thereof, such that the harvest yield prediction correlates to the crops' condition. As a non-limiting example, if plants in the test farm area show signs of disease, a predicted harvest yield may be lower than if the plants are healthy, with different diseases and severities of diseases resulting in different predicted yields. As another non-limiting example, if the plants show a higher degree of fruit bearing (e.g., if more fruits are shown in an image of the plants), the resulting predicted yield may be higher.

In some embodiments, the output module 140 may include or may be included in a mobile communication device (not shown) used for displaying the growing recommendation. In another embodiment, the output module 140 may transmit the growing recommendation to a remote device via, e.g., a transmission module (not shown). In some embodiments, the growing recommendation may also be uploaded to a website.

In some embodiments, the system 100 may further include a database 170. The database 170 may be configured to store the generated predictive function. Alternatively or collectively, the generated prediction model may be stored on a remote server. The database 170 may further include the training set, a testing set, a validation set, or a combination thereof.

It should be noted that the sensor module 120 is included in the system 100 merely for simplicity purposes and without limitations on the disclosed embodiments. In an embodiment, the sensor module 120 may be remote from the system 100 and may transmit sensor data via, e.g., telecommunication, radio, the Internet, and so on.

The processing circuitry 150 may comprise or be a component of a processor (not shown) or an array of processors coupled to the memory 160. The memory 160 contains instructions that can be executed by the processing circuitry 150. The instructions, when executed by the processing circuitry 150, cause the processing circuitry 150 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing circuitry 150 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

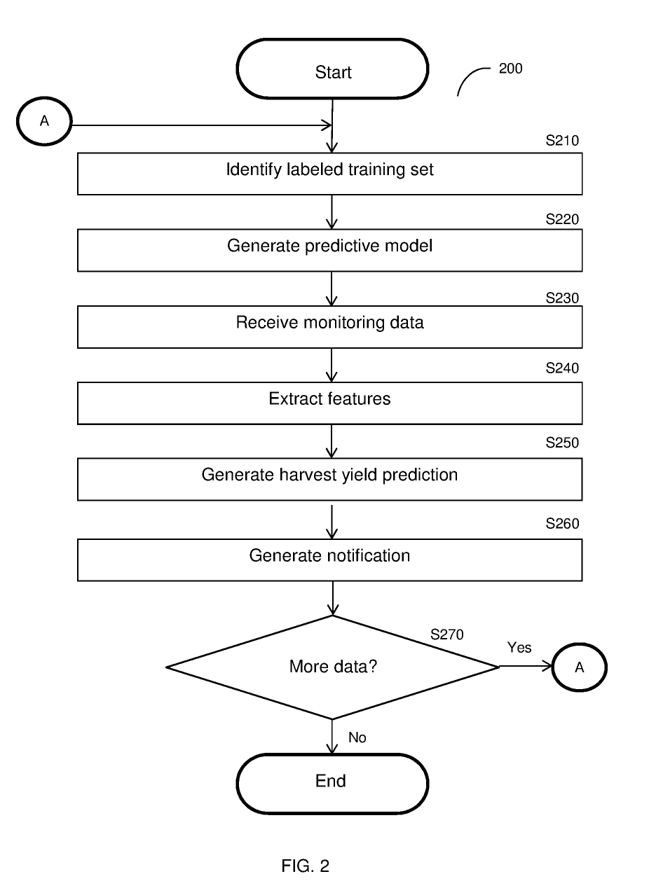

FIG. 2 shows a flowchart 200 illustrating a method for harvest yield prediction according to an embodiment.

At optional S210, a labeled training set may be identified. In an embodiment, the training set may include one or more training inputs such as, but not limited to, a sequence of training images of a target area containing at least one crop, at least one environmental sensor input, a transformation thereof, a combination thereof, and the like. In a further embodiment, the training set may further include training outputs such as, e.g., a crop condition as of the capturing of the training inputs, a crop condition after training input capture, historical harvest yields for training inputs, and so on. The training inputs may have a predetermined input structure as described further herein above with respect to FIG. 1.

In an embodiment, the training set may be retrieved or generated and labeled. In a further embodiment, the training inputs may be labeled automatically based on, e.g., analysis of the training inputs. For example, the labeling may be based on machine vision processing of a sequence of training images. In another embodiment, the training inputs may be labeled manually, i.e., based on a user input regarding the plant featured therein.

In an embodiment, any of the training inputs may be labeled based on an analysis conducted during input capture. For example, a crop condition may be visible in the training image sequence. In another embodiment, any of the training inputs may be labeled based on an analysis of post-input capture information. For example, the labeled crop condition may be derived from information available after capturing of the last image of the training image sequence. This may enable labeling of training sequences with future crop conditions of crops monitored in the training phase and allows, in the test phase, for early detection of tendencies toward particular plant conditions. Thus, the training inputs may be labeled to note indicators of subsequent disease. For example, the training input labels may identify fungal fruiting bodies on a plant indicative of future diseases caused by the fungus (e.g., damping off, mildew formation, cankers, and so on).

The training inputs to be labeled may be captured using, for example, stationary high resolution cameras placed in one or more farms, a terrestrial or aerial drone including a camera operated in the farms, a camera mounted to a rail or terrestrial vehicle on the farms, environmental sensor units (e.g., temperature, humidity, irradiance sensors, etc.), and the like. The labels may include, but are not limited to, a health state, a plant yield at harvest, a maturity parameter of the plant indicating the state of the plant relative to its initial and ready-for-harvesting forms, a color, a size, a shape, or a combination thereof. The training inputs may include images such as, for example, an extended sequence of images, a sequence of images extracted from an extended sequence of images, images extracted from a video stream, or a combination thereof. The images may further be extracted based on, e.g., a predetermined sampling scheme. For example, the training image sequences may include between 2 and 20 training images.

The training sequence may further include environmental sensor inputs. The environmental sensor inputs may be associated with a training image sequence. The environmental parameter values may further relate to time periods beyond the time periods in which the training images were captured. For example, an environmental parameter value associated with a sequence of training images may be a projection value relating to a later time period.

The training image labels may further indicate attributes of specific parts of a crop.

Such indication may be useful in identifying crop conditions related only to specific parts of the crop. For example, for disease detection of tomato yellow leaf curl virus (TYLCV), upper new leaves (i.e., the youngest leaves of the plant) may be specifically identified in the training images (and, accordingly, in subsequent test images). As a result, specific parts of the crop may be analyzed to determine plant conditions. Moreover, the training images may include multiple crops, and appropriate image processing may be performed respective of the crops.

At S220, a harvest yield prediction model is generated based on the labeled training inputs. In an embodiment, the harvest yield prediction model may be generated based on convolutional neural networks. The steps S210 and S220, collectively, may be utilized to build a classifier as described further herein above with respect to the classifier 130 of FIG. 1.

In an embodiment, S220 may further include testing, validation, or both, of the harvest yield prediction model. The testing and validation may be utilized to, e.g., refine, validate, or otherwise provide more accurate harvest yield predictions.

At S230, monitoring data is received or retrieved. The monitoring data relates to the crops for which harvest yield predictions are to be determined. In an embodiment, the monitoring data may include a sequence of images, environmental sensor inputs, or both. Alternatively or collectively, the monitoring data may include other characteristics of the farm area or the crops therein related to crop growth such as, but not limited to, soil type, soil measurements (e.g., salinity, pH, etc.), seed type, sowing time, amount and scheduling of irrigation, type and scheduling of fertilizer, type and scheduling of pesticides and/or insecticides, and so on.

At S240, features to be utilized as inputs to a harvest yield prediction model are extracted based on the monitoring data. The features are related to development of the crop and may include crop stage (e.g., a period of time relative to the life cycle of the crop), crop size, and disease distribution. The features may also include environmental parameters such as, but not limited to, temperature, humidity, soil moisture, insect and pest activity, radiation intensity, a subsequent meteorological forecast, sunlight, and the like. In an embodiment, S240 may include analyzing the monitoring data, applying at least one transformation to the monitoring data, or both. In a further embodiment, S240 may include analyzing, via machine vision, each image of the monitoring data to identify attributes of the monitored plants. The attributes may include, but are not limited to, at least one color of a crop, a color ration between portions of a crop, texture, color division, size, shape, growth data, or a combination thereof.

At S250, a harvest yield prediction is generated for the at least one crop in the target area. In an embodiment, S250 includes applying a harvest yield prediction model to the determined features. In a further embodiment, S250 may also include selecting the harvest yield prediction model based on the determined features. The selection may be performed by, for example, a classifier (e.g., the classifier 130, FIG. 1).

At optional S260, a notification may be generated. The notification may indicate the harvest yield prediction. The notification may be sent to, e.g., a mobile device of an owner of the target area to a website accessible to the owner of the target area, and the like.

In an embodiment, S260 may further include determining if the predicted harvest yield has changed (e.g., above a predetermined threshold) since a previous prediction. In a further embodiment, the notification may be generated only if the predicted harvest yield has changed. Thus, for example, a farmer may only be notified of the predicted harvest yield if the prediction has changed notably since a prior point in time, thereby allowing the farmer to plan accordingly.

At 270, it is determined if additional monitoring data has been received and, if so, execution continues with S230; otherwise, execution terminates. In an embodiment, additional inputs may be received continuously or periodically, thereby allowing for monitoring of the harvest yield predictions based on changes in, e.g., crop condition.

It should be noted that, in some embodiments, the steps S210 and S220 may be performed offline, at a remote time from the other steps of the method of FIG. 2, or both. In an embodiment, the training input labeling and approximation of predictive functions may be performed only once initially, and may be repeated only as desired to determine, e.g., plant conditions of new types of plants, newly identified plant conditions, and so on. Further, in an embodiment, the prediction model may be further subjected to testing, validation, or both, thereby allowing for improvement of the prediction model, confirmation of the accuracy of the prediction model, or both.

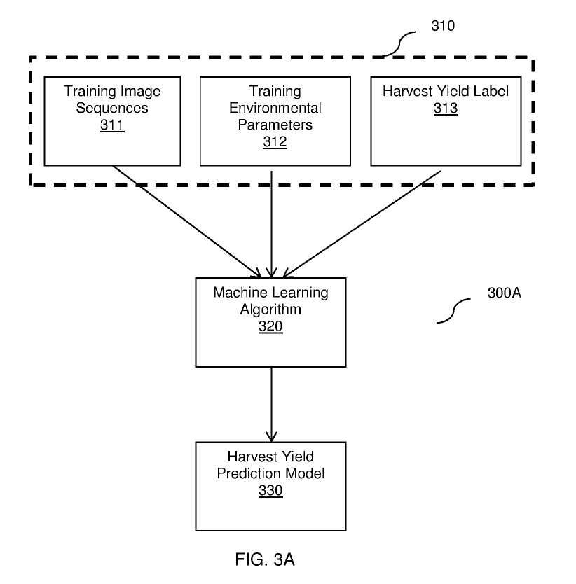

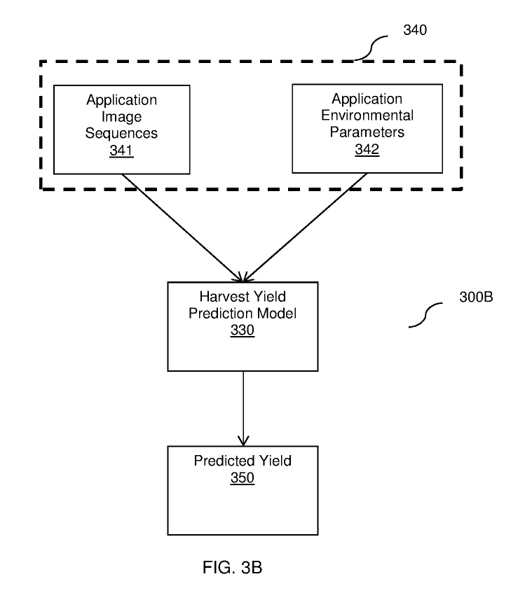

FIGS. 3A and 3B illustrate phases of a method for plant monitoring to predict harvest yields according to an embodiment.

FIG. 3A shows a flow diagram 300A illustrating a training phase of a method for crop monitoring to predict harvest yields according to an embodiment. A labeled training set 310 is fed to a machine learning algorithm 320 to generate a harvest yield prediction model 330.

The labeled training set 310 includes sequences of training inputs such as training image sequence 311 featuring farm areas containing plants as well as a training environmental parameter sequence 312. The environmental parameter sequence 312 may include, but are not limited to, values of humidity, temperature, soil moisture, radiation intensity, sunlight, subsequent meteorological forecasts, and so on. The labeled training set 310 also includes training outputs such as a time to harvest label 313 indicating a yield of the plant at one or more future harvest times with respect to the training image sequence 311 and the training environmental parameter sequence 312. The yield of the crop may be expressed as a crop yield at the harvest time. For example, the crop yield may be measured based on a quantity of crop parts (e.g., fruits), a total weight of yield, a total volume of yield, a volume of yield per unit area, a seed production value, and so on. The yield may be a real-value scalar. The training image sequences may be collected via continuous monitoring from an initial crop stage (e.g., flowering) to harvest. In an embodiment, the environmental parameters 312 may be collected at the same or substantially the same time as the training image sequence 311. The labeled training set 310 may be sampled based on, e.g., a predefined sampling scheme.

In an embodiment, at least some of the data of the training input set 310 may be utilized as features that are input to the machine learning algorithm 320. In a further embodiment, the features may be extracted based on analysis of any of the application image sequence 311 and the application environmental parameter sequence 312. The features are related to development of the crop and may include crop stage, crop size, and disease distribution. The features may also include environmental parameters such as, but not limited to, temperature, humidity, soil moisture, insect and pest activity, radiation intensity, a subsequent meteorological forecast, sunlight, and the like. For example, the analysis may include machine vision analysis to identify attributes of crops shown in the images (e.g., color, size, shape, etc.), and at least some of the attributes may be utilized as features. Further, the features may include characteristics of the crops, the target area, or both.

Upon feeding the training set 310 to the machine learning algorithm 320, a harvest yield prediction model 330 may be generated. The harvest yield model 330 may be utilized to predict times of harvest based on subsequent test inputs. The harvest yield prediction model 330 may further provide risk scores indicating likelihoods that the predicted harvest yields are accurate. In an embodiment, the machine learning algorithm 320 is a convolutional neural network.

FIG. 3B shows a flow diagram 300B illustrating an application phase of a method for plant monitoring to predict harvest yields according to an embodiment. A predicted yield 350 is generated based on an application input set 340 and the harvest yield prediction model 330.

The application input set 340 may include sequences of applied inputs such as an application image sequence 341 of a target area including at least one crop and an application environmental parameter sequence 342. The application input set 340 may be transmitted from a stationary sensor module installed in the target area. Each application input of the application input set 340 may have the same input structure as a respective training input of the training input set 310. The predicted yield 350 may include a predicted harvest yield, a risk score indicating a probability that the predicted harvest yield is accurate, or both.

In an embodiment, at least some of the data of the application input set 340 may be utilized as features that are input to the harvest yield prediction model 330. Alternatively or collectively, any of the application image sequence 341 and the application environmental parameter sequence 342 may be analyzed, and the features may include results of the analysis. For example, the analysis may include machine vision analysis to identify attributes of crops shown in the images (e.g., color, size, shape, etc.), and the attributes may be utilized as features instead of or in addition to any of the application environmental parameters. Further, the features may include characteristics of crops, of the target area, or both.

Fig. 4 is an example flowchart 400 illustrating a method for crop monitoring for identification of deviations from normal growth patterns based on image analysis. The identified deviations may be utilized, e.g., as features for a harvest yield prediction model to determine harvest yield predictions.

At S410, an input set is identified with respect to a target area including at least one crop. The input set may include an image sequence including images featuring the target area. The identified input set may be an existing input set received from a storage, or may be generated using one or more sensors (such as sensors of the sensor module 120, FIG. 1).

At S420, at least two consecutive images of the image sequence are analyzed. The analysis may include image processing such as, e.g., machine vision. The analysis includes identifying a time of capture for each analyzed image. In an embodiment, the analysis may result in identification of a type of the crop, a stage of development of the crop, or both. The analysis may result in identification of crop attributes such as, but not limited to, a number of leaves or branches, colors of various plant crop, a size of the crop, a size of a fruit of the crop, a maturity of the crop, and so on.

At S430, based on the times of capture of the analyzed images, a normal growth pattern of the at least one crop at the times of capture is determined. The normal growth pattern indicates the appearance or change of certain crop attributes at various points in the crops' development. For example, the normal growth pattern may indicate attributes such as, for various points in time, an expected number of leaves, number of branches, color of crop parts, size of the crop, size of a fruit, a maturity, and so on.

At S440, based on the analysis, it is checked whether the identified crop attributes deviate from the normal growth pattern and, if so, execution continues with S450; otherwise, execution terminates. In an embodiment, the identified crop attributes may deviate from the normal growth pattern if, e.g., the difference between one or more of the crop attributes and the respective normal growth pattern attributes is above a predetermined threshold. In a further embodiment, the difference between the plant attributes and the respective normal growth pattern attributes may be averaged or subject to a weighted average. In such an embodiment, a deviation may be determined if the average or weighted average is above a predetermined threshold.

At S450, a deviation from the normal growth pattern is identified. In an optional embodiment, S450 may include generating a notification regarding the deviation. The notification may further include a corrective action and/or a growing recommendation. The identified deviation may be further utilized to predict harvest yield.

It should be noted that the method of FIG. 4 may be iteratively repeated, thereby allowing for continuous monitoring of deviations. Such continuous monitoring allows for improved identification of potential growth issues and more rapid responses to such issues.

It should also be noted that the term “plant,” as used herein, may refer to a whole plant, to a part of a plant, to a group of plants, or a combination thereof. Additionally, it should be noted that various embodiments disclosed herein are described with respect to a target area that is a farm area merely for simplicity purposes and without limitation on the disclosed embodiments. The embodiments disclosed herein may be equally applied to various areas in which plants are grown and may be monitored to predict a yield thereof without departing from the scope of the disclosure. For example, as noted above, the disclosed embodiments may be applied to indoor growing areas, outdoor growing areas, incubators, and the like.

It should further be noted that, as described herein, the term “machine learning techniques” may be used to refer to methods that can automatically detect patterns in data and use the detected patterns to predict future data, perform any other decision-making, or both, in spite of uncertainty. In particular, the present disclosure relates to supervised learning approaches in which inputs are linked to outputs via a training data set. It should be noted that unsupervised learning approaches may be utilized without departing from the scope of the disclosure.

The training set may include a high number of training examples (e.g., pairings of training inputs and outputs). Each input may be associated with environmental parameters such as, but not limited to, temperature, humidity, radiation intensity, sunlight, subsequent meteorological forecasts, and so on. In some embodiments, the inputs may preferably have a similar predetermined training input structure. For example, the input structure for an image input may include an image parameter and an image frequency parameter. The image parameter may indicate an amount of successive images in an image sequence. The image frequency parameter may indicate one or more time intervals between successive captures of images of an input. The time intervals may be the same (e.g., when images are captured periodically) or different.

The input structure for an environmental parameter may include corresponding environmental parameters and environmental frequency parameters. Each environmental parameter may indicate an amount of successive values of a given environmental parameter. Each environmental frequency parameter may indicate one or more time intervals between successive captures of environmental parameters of an input. The time intervals may be the same (e.g., when environmental parameters are captured periodically) or different.

The training outputs may be a categorical variable such as, but not limited to, one or more predicted harvest yields. Generally, the machine learning techniques may be formalized as an approximation of a function (e.g., “y=f(x),” wherein x is an input, y is an output, and f is a function applied to x to yield y). Such machine learning techniques may be utilized to make predictions using an estimated function (e.g., “ŷ=\hat{f}(x),” where ŷ is the approximated output, x is the input, and f is the approximated function). Such function approximation enables prediction of new test inputs. The approximation may further provide a risk score indicating a likelihood that the approximated output is correct.

Each application feature may have the same input structure as a labeled training set.

Thus, the set of application features may have the same number of input parameters as that of a labeled training set, and the parameters may be taken at similar time intervals. The training inputs of the labeled training set may be obtained directly (i.e., they may include captured images, environmental sensor inputs, or both) or indirectly (i.e., they may be transformed from captured images, environmental sensor inputs, or both).

It should be noted that various embodiments disclosed herein are described with respect to harvest yield prediction for plants merely for simplicity purposes and without limitation on the disclosed embodiments. Some disclosed embodiments may be equally applied to monitoring data of other organisms such as, for example, fungi or bacterial colonies, to predict yields at various points in time without departing from the scope of the disclosure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for predicting harvest yield, comprising:
receiving monitoring data related to at least one crop, wherein the monitoring data includes at least one multimedia content element showing the at least one crop;
analyzing, via machine vision, the at least one multimedia content element;
extracting, based on the analysis, a plurality of features related to development of the at least one crop; and
generating a harvest yield prediction for the at least one crop based on the extracted features and a prediction model, wherein the prediction model is based on a training set including at least one training input and at least one training output, wherein each training output corresponds to a training input.

2. The method of claim 1, wherein the monitoring data further includes at least one set of environmental sensor inputs, wherein the extraction is further based on the at least one set of environmental sensor inputs.

3. The method of claim 2, wherein the extracted features include at least one of: crop stage, crop size, and disease distribution.

4. The method of claim 1, wherein the monitoring data further includes at least one characteristic, wherein the extraction is further based on the at least one characteristic, wherein each characteristic is any of: a soil type, a soil measurement, a seed type, a sowing time, an amount of irrigation, a scheduling of irrigation, a type of fertilizer, a scheduling of fertilizer application, a type of pesticide, and a scheduling of pesticide application.

5. The method of claim 1, wherein the at least one multimedia content element includes at least one high resolution multimedia content element.

6. The method of claim 1, wherein analyzing the at least one multimedia content element further comprises:
identifying at least one attribute of the at least one crop.

7. The method of claim 6, wherein the at least one attribute includes at least one of:
at least one color of the plant, at least one color ration between portions of the plant, at least one texture, at least one color division, at least one size, at least one shape, and growth data.

8. The method of claim 1, wherein the at least one multimedia content element includes an image sequence of at least two consecutive images, further comprising:
determining a normal growth pattern of the at least one crop;
analyzing the image sequence to identify a plurality of plant attributes;
determining whether the identified plant attributes deviate from the normal growth pattern; and
identifying at least one deviation from the normal growth pattern, when it is determined that the identified plant attributes deviate from the normal growth pattern, wherein the extraction is further based on the identified at least one deviation.

9. The method of claim 1, wherein the prediction model is generated via a convolutional neural network.

10. A non-transitory computer readable medium having stored thereon instructions for causing a processing circuitry to execute a process, the process comprising:
receiving monitoring data related to at least one crop, wherein the monitoring data includes at least one multimedia content element showing the at least one crop;
analyzing, via machine vision, the at least one multimedia content element;
extracting, based on the analysis, a plurality of features related to development of the at least one crop; and
generating a harvest yield prediction for the at least one crop based on the extracted features and a prediction model, wherein the prediction model is based on a training set including at least one training input and at least one training output, wherein each training output corresponds to a training input.

11. A system for predicting harvest yield, comprising:
a processing circuitry; and
a memory, the memory containing instructions that, when executed by the processing circuitry, configure the system to:
receive monitoring data related to at least one crop, wherein the monitoring data includes at least one multimedia content element showing the at least one crop;
analyze, via machine vision, the at least one multimedia content element;
extract, based on the analysis, a plurality of features related to development of the at least one crop; and
generate a harvest yield prediction for the at least one crop based on the extracted features and a prediction model, wherein the prediction model is based on a training set including at least one training input and at least one training output, wherein each training output corresponds to a training input.

12. The system of claim 11, wherein the monitoring data further includes at least one set of environmental sensor inputs, wherein the extraction is further based on the at least one set of environmental sensor inputs.

13. The system of claim 12, wherein the extracted features include at least one of:
crop stage, crop size, and disease distribution.

14. The system of claim 11, wherein the monitoring data further includes at least one characteristic, wherein the extraction is further based on the at least one characteristic, wherein each characteristic is any of: a soil type, a soil measurement, a seed type, a sowing time, an amount of irrigation, a scheduling of irrigation, a type of fertilizer, a scheduling of fertilizer application, a type of pesticide, and a scheduling of pesticide application.

15. The system of claim 11, wherein the at least one multimedia content element includes at least one high resolution multimedia content element.

16. The system of claim 11, wherein the system is further configured to:
identify at least one attribute of the at least one crop.

17. The system of claim 16, wherein the at least one attribute includes at least one of: at least one color of the plant, at least one color ration between portions of the plant, at least one texture, at least one color division, at least one size, at least one shape, and growth data.

18. The system of claim 11, wherein the at least one multimedia content element includes an image sequence of at least two consecutive images, wherein the system is further configured to:
determine a normal growth pattern of the at least one crop;
analyze the image sequence to identify a plurality of plant attributes;
determine whether the identified plant attributes deviate from the normal growth pattern; and
identify at least one deviation from the normal growth pattern, when it is determined that the identified plant attributes deviate from the normal growth pattern, wherein the extraction is further based on the identified at least one deviation.

19. The system of claim 11, wherein the prediction model is generated via a convolutional neural network.
